(19) United States
(12) Patent Application Publication
(10) Pub. No.: US 2017/0149745 A1
(43) Pub. Date: May 25, 2017

(54) WIRELESS COMMUNICATION CONFIGURATION DEVICE

(71) Applicant: Carrier Corporation, Jupiter, FL (US)

(72) Inventor: Penghe Geng, Vernon, CT (US)

(21) Appl. No.: 15/351,648

(22) Filed: Nov. 15, 2016

Related U.S. Application Data
(60) Provisional application No. 62/257,543, filed on Nov. 19, 2015.

(51) Int. Cl. H04L 29/06; H04L 29/08; H04L 12/24

(52) U.S. Cl. CPC H04L 63/0428; H04L 41/0806; H04L 67/12; H04L 63/08

(57) ABSTRACT

The described herein relates to transferring communication credentials from a configuration device to a smart device. The transfer of the communication credentials includes initialization of a configuration card with the communication credentials by the configuration device. Further, the communication credentials are automatically transferred from the configuration card to the smart device in response to the smart device coupling with the configuration card. The smart device then connects to the network based on the communication credentials in the configuration card.

### CROSS-REFERENCE TO RELATED APPLICATIONS

This application claims priority to and the benefit of U.S. Provisional Patent Application No. 62/257,543 filed on Nov. 19, 2015, and all the benefits accruing therefrom under 35 U.S.C. §119, the content of which is incorporated herein in its entirety by reference.

### BACKGROUND

The disclosure relates generally to a communication configuration device, and more specifically, to quickly and securely transferring wireless communication credentials to a smart device.

In general, smart devices can be networked sensing and computing devices embedded with electronics, software, sensors, and network connectivity, which enables the smart devices to collect and exchange data across the network. These smart devices are usually designed for dedicated purpose with a limited set of user interfaces. Often times, the smart devices are “headless” (i.e. without keyboard or screen), which makes configuring these devices extremely difficult for end users. Contemporary implementations have yet to provide an easy mechanism to overcome present configuration shortcomings and difficulties.

### SUMMARY

According to one embodiment, a method for transferring communication credentials from a configuration device to a smart device is provided. The method includes initializing, by the configuration device, a configuration card with the communication credentials stored on the configuration device; automatically transferring the communication credentials on the configuration card to the smart device in response to a coupling of the configuration card and the smart device; and connecting, by the smart device, to a network based on the communication credentials transferred from the configuration card.

According to another embodiment or the method embodiment above, the initializing of the configuration card can comprise receiving the configuration card by the configuration device; and automatically transferring any communication credentials that are preloaded on the configuration device in response to the receiving of the configuration card.

According to another embodiment or any of the method embodiments above, the receiving of the configuration card by the configuration device can comprise the configuration card being inserted into a slot of the configuration device.

According to another embodiment or any of the method embodiments above, the coupling of the configuration card and the smart device can comprise the configuration card being inserted into a slot of the smart device.

According to another embodiment or any of the method embodiments above, the communication credentials can include network protocols for establishing and maintaining connectivity to the network by the smart device.

According to another embodiment or any of the method embodiments above, a method can further comprise executing the automatic transfer of the communication credentials to a plurality of smart devices to connect the plurality of smart device to the network based on the communication credentials.

According to another embodiment or any of the method embodiments above, the smart device can be a headless device embedded with electronics and software.

According to another embodiment or any of the method embodiments above, the configuration card can be integrated into the smart device.

According to one embodiment, a system for transferring communication credentials, comprising a configuration device configured to store the communication credentials; a configuration card; and a smart device is provide. The system is configured to initialize the configuration card with the communication credentials stored on the configuration device; automatically transfer the communication credentials on the configuration card to the smart device in response to a coupling of the configuration card and the smart device; and cause the smart device to connect to a network based on the communication credentials transferred from the configuration card.

According to another embodiment or the system embodiment above, the system can be configured to initialize the configuration card with the communication credentials by receiving the configuration card by the configuration device; and automatically transferring any preloaded communication credentials that are preloaded on the configuration device in response to the receiving of the configuration card.

According to another embodiment or any of the system embodiments above, the coupling of the configuration card and the smart device can comprise the configuration card being inserted into a slot of the configuration device.

According to another embodiment or any of the system embodiments above, the receiving of the configuration card by the smart device can comprise the configuration card being inserted into a slot of the smart device.

According to another embodiment or any of the system embodiments above, the communication credentials can include network protocols for establishing and maintaining connectivity to the network by the smart device.

According to another embodiment or any of the system embodiments above, the system can further be configured to execute the automatic transfer of the communication credentials to a plurality of smart devices to cause the plurality of smart device to connect to the network based on the communication credentials.

According to another embodiment or any of the system embodiments above, the smart device can be a headless device embedded with electronics and software.

According to another embodiment or any of the system embodiments above, the configuration card can be integrated into the smart device.

Additional features and advantages are realized through the techniques of embodiments herein. Other embodiments and aspects are described in detail herein. For a better understanding with the advantages and the features, refer to the description and to the drawings.

### BRIEF DESCRIPTION OF THE SEVERAL VIEWS OF THE DRAWINGS

The forgoing and other features, and advantages of the disclosure are apparent from the following detailed description taken in conjunction with the accompanying drawings in which:

FIG. 1 illustrates a wireless communication configuration system in accordance with an embodiment;

FIG. 2 illustrates a process flow of a wireless communication configuration system in accordance with an embodiment;

FIG. 3 illustrates another process flow of a wireless communication configuration system in accordance with an embodiment; and

FIG. 4 illustrates a processing system in accordance with an embodiment.

### DETAILED DESCRIPTION

In view of the above, embodiments disclosed herein may include communication configuration system, method, and/or computer program product (herein configuration system) that is effective solution for quickly and securely transferring communication credentials from a configuration device to a smart device via a configuration card.

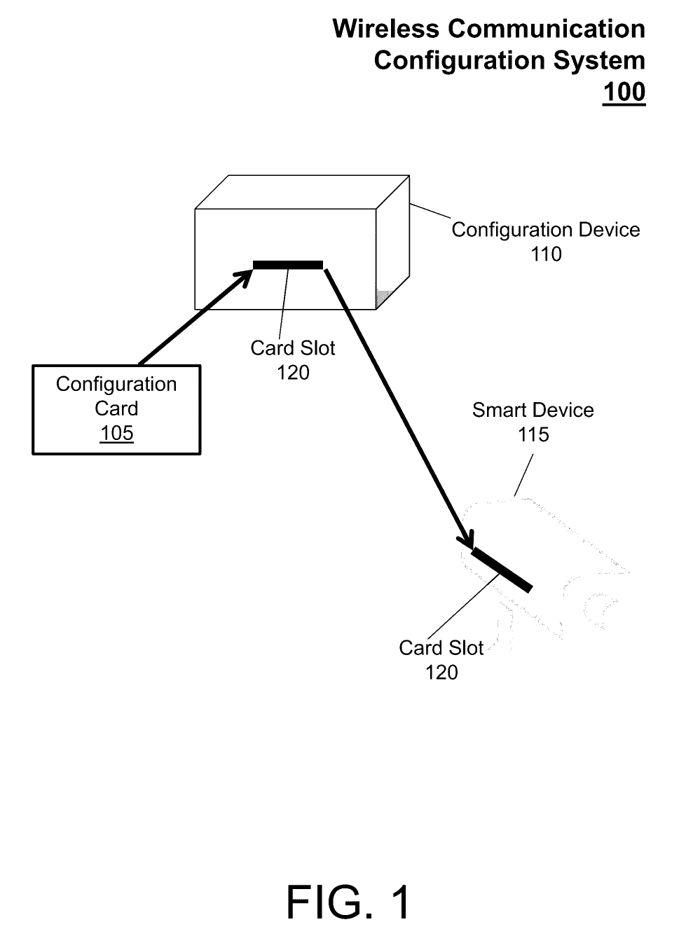

Turning now to FIG. 1, a configuration system 100 is generally shown in accordance with an embodiment. The configuration system 100 includes a configuration card 105, a configuration device 110, and a smart device 115. Note that the configuration device 110 and a smart device 115 include card slots 120.

The configuration system 100 can be any electronic system that includes a smart device that connects across a network. A network (also referred to as computer network or data network) is an electronic environment that allows a plurality of smart devices 115 to exchange data through a plurality of connections. The connections of the configuration system 100 can be established using wired and/or wireless media via communication credentials. The communication credentials include but are not limited to communication protocols, addresses, identifiers, keys, names, and the like that enable the smart device to connect to the configuration system 100. For example, the communication credentials can include network protocols for establishing and maintaining connectivity to the network by the smart device, such as a mechanism for automatically acquiring an internet protocol address within a specific range of a network.

The configuration card 105 can be any non-volatile memory card that can combine input/output functions with data storage for use in a smart device 115. The configuration card 105 can be in any form factor or size and can be adaptive to an electrically passive adapter to fit and function in a device built for a larger card. The configuration card 105 can communicate with the configuration device 110 and the smart device 115 by being coupled to these devices. For example, the configuration card 105 can be inserted into the card slots 120 and/or coupled through any communication interface, such as a wireless interface that supports near field communication (e.g., physical proximity), wireless fidelity, or other radio frequency. Examples of a configuration card 105 include but are not limited to pluggable modules, wireless fidelity (Wi-Fi) modules, secure digital standard-capacity (SDSC) cards, secure digital high-capacity (SDHC) cards, the secure digital extended-capacity (SDXC) cards, etc.

The configuration device 110 can by any computing device (e.g., a processing system as 400 as described below) configured to receive and store communication credentials from an external device and/or a user. The configuration device 110 can include one or more communication interfaces (e.g., card slot 120 or wireless interface) for connecting to the configuration card 105.

The smart device 115 is physical object embedded with electronics, software, sensors, and network connectivity and configured to receive communication credentials from the configuration card 105. The smart device 115 can also include a communication interface (e.g., card slot 120) for connecting to the configuration card 105. Examples of the smart device 115 can include inexpensive headless devices and sensors in a home and/or building. In an embodiment, the configuration card 105 can be integrated into the smart device 115, such that the smart device 115 itself can be coupled to the configuration device 110 and receive the communication credentials.

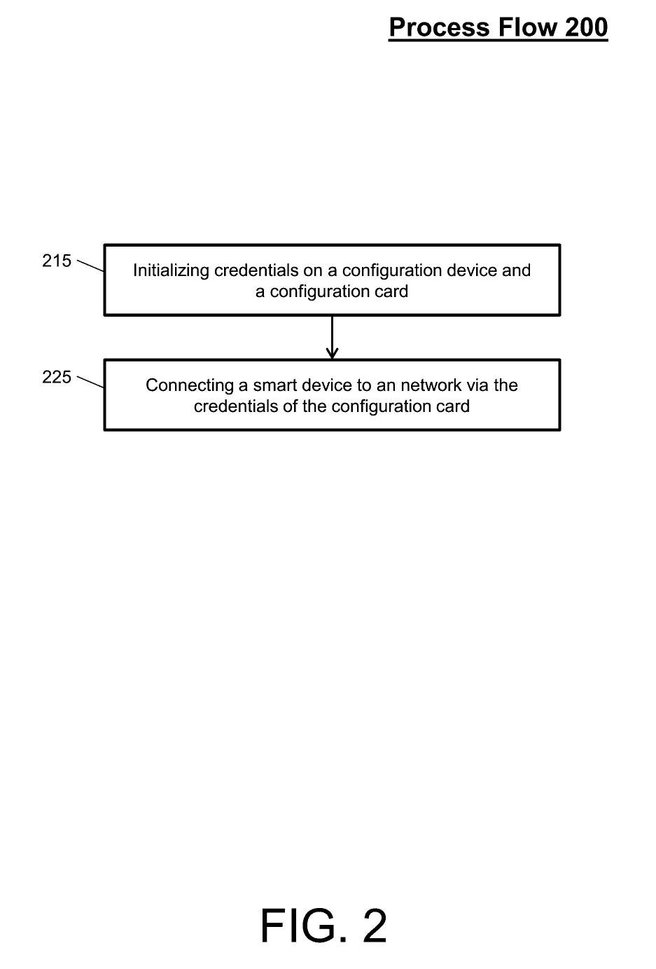

An example operation will now be described with respect to FIG. 2. FIG. 2 illustrates a process flow 200 of the configuration system 100 in accordance with an embodiment. The process flow 200 begins at block 215, where credentials are initialized on a configuration device 110 and a configuration card 105. For instance, the configuration card 105 can be inserted into the slot 120 of the configuration device 110. Once inserted, any preloaded communication credentials of the configuration device 110 are transferred (e.g., instantly transferred) from the configuration device 110 to the configuration card 105.

At block 225, the process flow 200 continues by connecting a smart device 115 to a network based on the credentials in the configuration card 105. For instance, the configuration card 105 can be inserted into the slot 120 of the smart device 110. Once inserted, any preloaded communication credentials are transferred (e.g., instantly transferred) from the configuration card 105 to the smart device 110. The smart device 110 can then connect to the configuration system 100 and be managed them through the configuration system 100 or other device (e.g., such as a smartphone).

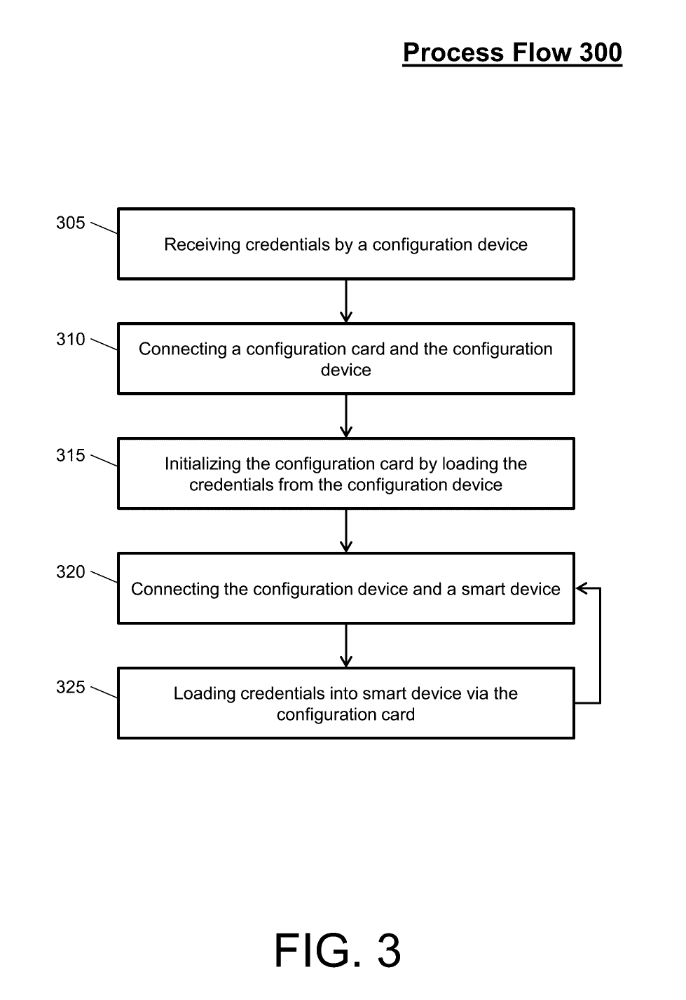

Turning now to FIG. 3, a process flow 300 of a configuration system in accordance with an embodiment. The process flow 300 begins at block 305, receiving credentials by a configuration device. The credentials can be communication credentials for connecting to a network. The credentials can be a user input, a preloaded configuration, or automatically generated based on a present network of the configuration device. In the latter example, the configuration device can connect to any network and then automatically establish a set of protocols, such as a range of internet protocol addresses, for connecting any subsequent smart device.

At block 310, a configuration card is connected to the configuration device. To connect the configuration card to the configuration device, the configuration card can be inserted into a slot of the configuration device to establish a physical connection. Also, the configuration card can be within a radio range or magnetic field of the configuration device so that communication between the configuration card and the configuration device can occur.

At block 315, the credentials are initialized on a configuration device and a configuration card. The configuration card can be initialized by loading the credentials from the configuration device to the configuration card. For instance, once the configuration card and the configuration device are connected, any preloaded communication credentials are automatically and transferred (e.g., instantly transferred) onto the configuration card.

At block 320, the configuration card is connected to a smart device. To connect the configuration card to the smart device, the configuration card can be inserted into a slot of the smart device to establish a physical connection. Also, the configuration card can be within a radio range or magnetic field of the smart device so that communication between the configuration card and the smart device can occur.

At block 325, the credentials are loaded into the smart device via the configuration card. For instance, once the configuration card and the smart device are connected, the communication credentials of the configuration card are automatically and transferred (e.g., instantly transferred) onto the smart device. In response, the smart device utilizes the credentials to connect to a network. The process flow can then loop back to block 320 where any subsequent smart devices can also be connected to the configuration device and loaded with the credentials. For example, if there is a need to configure a plurality of Wi-Fi devices, a Wi-Fi module can be quickly configured by a Wi-Fi configuration device so that the Wi-Fi module can be utilized to then transfer credentials to the plurality of Wi-Fi devices. Note that once all smart devices (a.k.a. a plurality of smart devices) are connected to the network, each smart device can be individually managed through a cloud technology and/or from a smartphone.

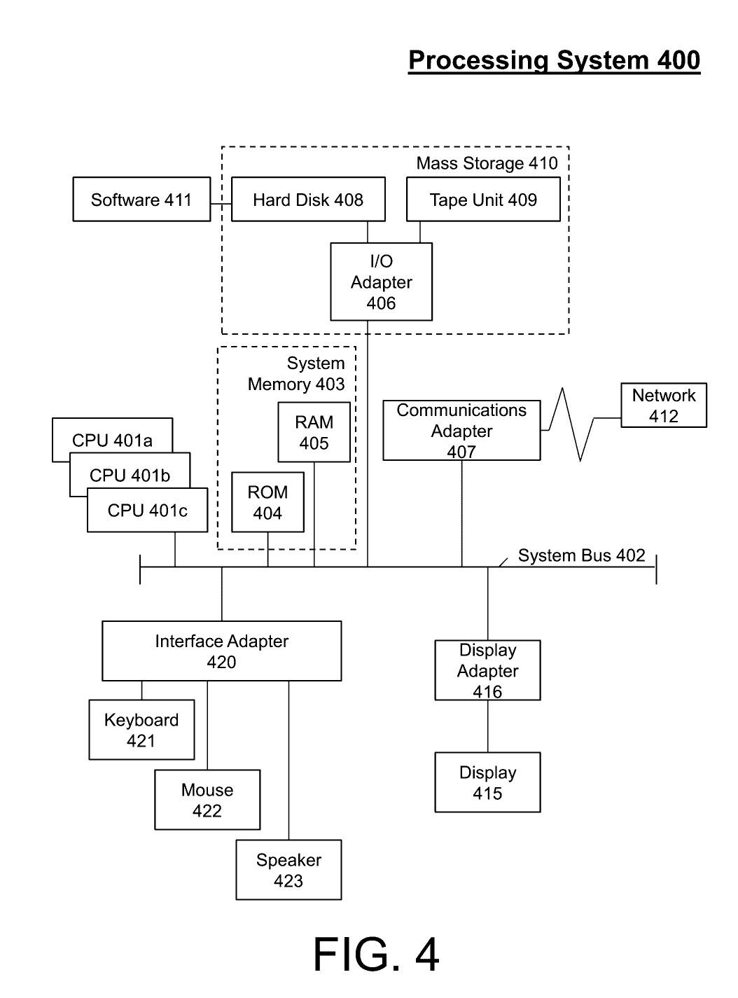

Referring now to FIG. 4, there is shown an embodiment of a processing system 400 for implementing the teachings herein. In this embodiment, the processing system 400 has one or more central processing units (processors) 401a, 401b, 401c, etc. (collectively or generically referred to as processor(s) 401). The processors 401, also referred to as processing circuits, are coupled via a system bus 402 to system memory 403 and various other components. The system memory 403 can include read only memory (ROM) 404 and random access memory (RAM) 405. The ROM 404 is coupled to system bus 402 and may include a basic input/output system (BIOS), which controls certain basic functions of the processing system 400. RAM is read-write memory coupled to system bus 402 for use by processors 401.

FIG. 4 further depicts an input/output (I/O) adapter 406 and a network adapter 407 coupled to the system bus 402. I/O adapter 406 may be a small computer system interface (SCSI) adapter that communicates with a hard disk 408 and/or tape storage drive 409 or any other similar component. I/O adapter 406, hard disk 408, and tape storage drive 409 are collectively referred to herein as mass storage 410. Software 411 for execution on processing system 400 may be stored in mass storage 410. The mass storage 410 is an example of a tangible storage medium readable by the processors 401, where the software 411 is stored as instructions for execution by the processors 401 to perform a method, such as the process flows of FIGS. 2-3. Network adapter 407 interconnects system bus 402 with an outside network 412 enabling processing system 400 to communicate with other such systems. A screen (e.g., a display monitor) 415 is connected to system bus 402 by display adapter 416, which may include a graphics controller to improve the performance of graphics intensive applications and a video controller. In one embodiment, adapters 406, 407, and 416 may be connected to one or more I/O buses that are connected to system bus 402 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 402 via an interface adapter 420 and the display adapter 416. A keyboard 421, mouse 422, and speaker 423 can be interconnected to system bus 402 via interface adapter 420, which may include, for example, a Super I/O chip integrating multiple device adapters into a single integrated circuit.

Thus, as configured in FIG. 4, processing system 405 includes processing capability in the form of processors 401, and, storage capability including system memory 403 and mass storage 410, input means such as keyboard 421 and mouse 422, and output capability including speaker 423 and display 415. In one embodiment, a portion of system memory 403 and mass storage 410 collectively store an operating system to coordinate the functions of the various components shown in FIG. 4.

Technical effects and benefits of embodiments herein include secure and quick transfer of wireless communication credentials across multiple smart devices for ease of connecting those devices to a network. Thus, embodiments described herein are necessarily rooted in configuration device and/or wireless configuration system to perform proactive operations to overcome problems specifically arising in the realm of the internet of things. For example, the configuration device is extremely easy to use for the Wi-Fi configuration, as it is a plug and play operation without hassles, no need for a full computer, no requirement for a smartphone, that support smart devices from different vendors and sources.

The present disclosure may be embodied in a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations described herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of embodiments herein.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for transferring communication credentials from a configuration device to a smart device, comprising:
initializing, by the configuration device, a configuration card with the communication credentials stored on the configuration device;
automatically transferring the communication credentials on the configuration card to the smart device in response to a coupling of the configuration card and the smart device; and
connecting, by the smart device, to a network based on the communication credentials transferred from the configuration card.

2. The method of claim 1, wherein the initializing of the configuration card comprises:
receiving the configuration card by the configuration device; and
automatically transferring any communication credentials that are preloaded on the configuration device in response to the receiving of the configuration card.

3. The method of claim 2, wherein the receiving of the configuration card by the configuration device comprises the configuration card being inserted into a slot of the configuration device or being coupled through a communication interface.

4. The method of claim 1, wherein the coupling of the configuration card and the smart device comprises the configuration card being inserted into a slot of the smart device or being coupled through a communication interface.

5. The method of claim 1, wherein the communication credentials include network protocols for establishing and maintaining connectivity to the network by the smart device.

6. The method of claim 1, further comprising executing the automatic transfer of the communication credentials to a plurality of smart devices to connect the plurality of smart device to the network based on the communication credentials.

7. The method of claim 1, wherein the smart device is a headless device embedded with electronics and software.

8. The method of claim 1, wherein the configuration card is integrated into the smart device.

9. A system for transferring communication credentials, comprising a configuration device configured to store the communication credentials;
a configuration card; and
a smart device;
wherein the system is configured to:
initialize the configuration card with the communication credentials stored on the configuration device;
automatically transfer the communication credentials on the configuration card to the smart device in response to a coupling of the configuration card and the smart device; and
cause the smart device to connect to a network based on the communication credentials transferred from the configuration card.

10. The system of claim 9, wherein the system is further configured to initialize the configuration card with the communication credentials by:
receiving the configuration card by the configuration device; and
automatically transferring any preloaded communication credentials that are preloaded on the configuration device in response to the receiving of the configuration card.

11. The system of claim 10, wherein the coupling of the configuration card and the smart device comprises the configuration card being inserted into a slot of the configuration device.

12. The system of claim 9, wherein the receiving of the configuration card by the smart device comprises the configuration card being inserted into a slot of the smart device.

13. The system of claim 9, wherein the communication credentials include network protocols for establishing and maintaining connectivity to the network by the smart device.

14. The system of claim 9, wherein the system is further configured to:
execute the automatic transfer of the communication credentials to a plurality of smart devices to cause the plurality of smart device to connect to the network based on the communication credentials.

15. The system of claim 9, wherein the smart device is a headless device embedded with electronics and software.
